(19) United States
(12) Patent Application Publication
(10) Pub. No.: US 2003/0177210 A1
(43) Pub. Date: Sep. 18, 2003

(54) Method and device for specifying initialization tasks for a peripheral device

(76) Inventor: Gary G. Stringham, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/095,251

(22) Filed: Mar. 12, 2002

(51) Int. Cl. G06F 15/177; G06F 15/16

(52) U.S. Cl. 709/222; 709/228

(57) ABSTRACT

A method and device for customizing a network peripheral device, the method comprising the steps of: sending a request with an ID for the peripheral device to a computer on the network requesting at least one initialization task; the computer searching a memory for the initialization task based on the peripheral device ID and retrieve that initialization task; and executing the retrieved task to cause a communication with the peripheral device to initialize the peripheral device. In one embodiment, the peripheral device ID is contained within a URL, and wherein the URL contains an address to a computer on the network, and the URL is used to request execution of the initialization task. In another embodiment of the invention, each of a plurality of different computers on the network retrieves a different initialization task and executes its respective retrieved initialization task to cause a communication with the peripheral device to initialize a different aspect of the peripheral device.

### FIELD OF THE INVENTION

The present invention relates generally to the field of peripheral devices, and more particularly, to initialization operations for such devices.

### BACKGROUND OF THE INVENTION

Printers and other peripheral type devices store programs and data in RAM, such as soft fonts, templates, forms, and various other items. However, when the peripheral device loses power, those programs, data, and other items are lost. When power is restored to the peripheral device, those programs, files, and other items must be re-downloaded into the peripheral device. Having a hard disk installed on the peripheral device solved some of these problems. However, many peripheral devices do not contain hard disks, and it would be expensive to install hard disks thereon.

### SUMMARY OF THE INVENTION

Briefly, the present invention comprises in one embodiment, a method for customizing a network peripheral device, comprising the steps of: sending a request with an ID for the peripheral device to a computer on the network requesting at least one initialization task; the computer searching a memory for the initialization task based on the peripheral device ID and retrieve that initialization task; and executing the retrieved task to cause a communication with the peripheral device to initialize the peripheral device.

In a variation of the present invention, the ID for the peripheral device is an IP address.

In a further variation of the present invention, the IP address is stored in a non-volatile memory of the peripheral device.

In a further variation of the present invention, the sending a request step comprises: obtaining a MAC address or equivalent for the peripheral device; broadcasting the MAC address on the network or on a subnet; obtaining an IP address that correlates to the MAC address; and sending the IP address as the ID of the peripheral device to the computer and requesting at least one initialization task.

In a further variation of the present invention, the initialization task is a script.

In a further variation of the present invention, the initialization task obtains a font from a location on the network and downloads the font to initialize the peripheral device with the font.

In a further variation of the present invention, the initialization task obtains a list and location of forms and/or templates from a location on the network and downloads them to initialize the peripheral device.

In a further variation of the present invention, the initialization task obtains a set of security keys, permissions, and/or passwords from a location on the network and downloads them a memory to initialize the peripheral device.

In a further variation of the present invention, the peripheral device ID is contained within a URL, and wherein the URL contains an address to a computer on the network, and the URL is used to request execution of the initialization task.

In a further variation of the present invention, the peripheral device is a printer.

In a further variation of the present invention, the sending step comprises broadcasting the request on the network.

In a further variation of the present invention, each of a plurality of different computers on the network retrieves a different initialization task and executes its respective retrieved initialization task to cause a communication with the peripheral device to initialize a different aspect of the peripheral device.

In a further variation of the present invention, each of the different initialization tasks has a priority, and wherein the peripheral device receives the different communications and then initializes in the sequence of the priority.

In a further embodiment of the present invention, a peripheral device is provided, comprising: a device functional engine; a network communications module; a small non-volatile memory containing an ID or a reference for an ID for the peripheral device; and a boot program that sends a request via the network communications module for an initialization task and receives a communication from the network that initializes the peripheral device.

In a further variation of the present invention, the network includes a plurality of listening computers, and wherein the boot program contains code to send the request for an initialization task via the network communications module to the plurality of listening computers, and wherein the peripheral device receives a different communication from a plurality of the different listening computers, with each communication initializing a different aspect of the peripheral device.

### BRIEF DESCRIPTION OF THE DRAWINGS

FIG. 1 is a schematic block diagram of a peripheral device in accordance with the present invention.

FIG. 2 is a schematic flow chart of a first embodiment of the present invention.

FIG. 3 is a schematic flow chart of a second embodiment of a method of the present invention.

### DETAIL DESCRIPTION OF THE PREFERRED EMBODIMENT

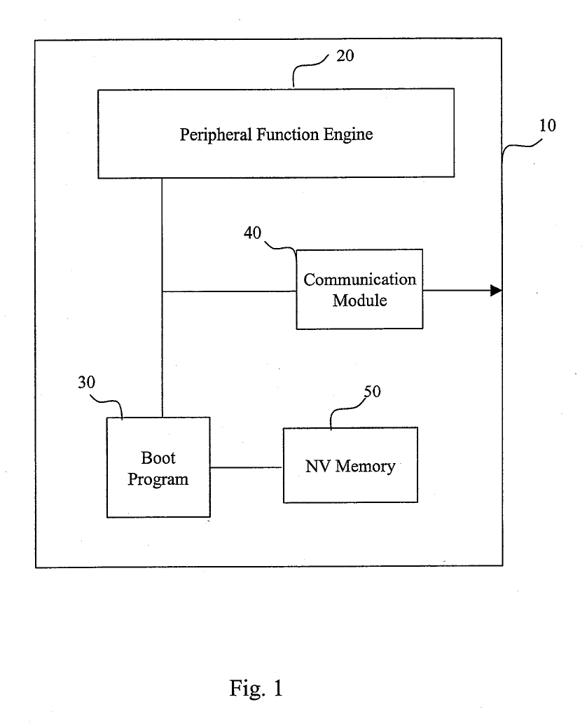

Referring now to FIG. 1, there is shown a hardware embodiment in accordance with the present invention. A peripheral device 10 is shown in the figure. The peripheral device includes a peripheral function engine 20, a boot program 30, a communication module 40, and an nonvolatile memory 50. By way of example but not by way of limitation, the peripheral device could be a printer, or multifunction printing device, and the peripheral function engine 20 could comprise a printing engine. Alternatively, the peripheral device could comprise a display, a copier, network scanner (such as HP's Digital Sender,) a network fax machine, a weather station collecting data, a water-level sensor at a mountain reservoir, security or traffic cameras which transmit images and could receive instructions for changing camera angle or zoom, monitoring and control station for heating and air conditioning for a large building, satellite tracking stations in remote locations, or monitoring and control for power substations in various locations, or any other device type. Such peripheral devices 10 include a boot program 30 for initializing the functional engine to carry out its intended functional purpose. The present invention further includes a communication module 14, which may comprise simply a network or other I/O cards. In a preferred embodiment, this communication module would include a protocol stack such as a TCP/IP protocol stack. The communications module 40 may take a variety of different configurations which may access a wide area network (WAN), an internet network, a public telephone network or a private value added network. Alternatively, the communications network can be implemented using any combination of the different kinds of communications networks. In a preferred embodiment, the communications module 40 is a TCP/IP communications controller with appropriate digital address accessible over the Internet. Note that the “hardware” portion of this communications module could have a protocol stack which could be ethernet, token ring, bluetooth, IEEE802.11 (B), or any other convenient software protocol to facilitate the transfer of IP packets over a network.

The nonvolatile memory 50 for peripheral devices typically is provided with a small capacity. Such small capacity is not sufficient to contain initialization settings, programs and other initialization requirements for the peripheral device. Accordingly, the boot program 30 is designed to access the initialization styles, programs, and other data by accessing a computer over the network.

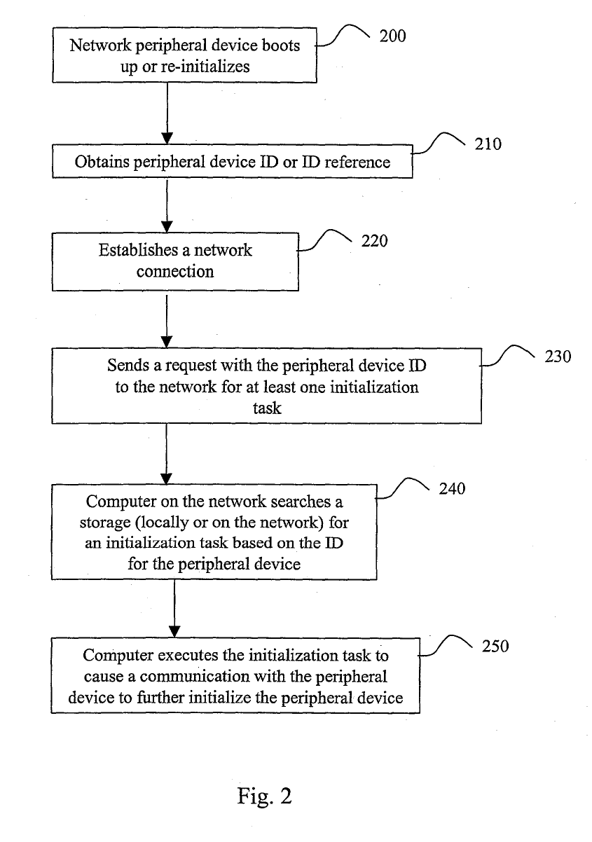

Referring now to FIG. 2, there is shown a block diagram flow chart for a first embodiment of a method for operating the present invention. The first step in the method, represented by block 200, is the booting up or the re-initialization of the peripheral device 10.

Referring to block 210, a step is provided of obtaining a peripheral device ID or an ID reference from the nonvolatile memory 50 or another convenient location. In one embodiment of the present invention, the ID may be obtained from the peripheral device itself. In another embodiment of the present invention, an ID reference, such as a MAC address or other equivalent address may be obtained from within the peripheral device and used to obtain the peripheral device ID. In a yet further embodiment of the present invention, the ID or the ID reference for the peripheral device could be buried within a network address such as a URL. For example, the URL could contain a unique number or string constituting its ID or ID reference, for example, “http://printers.hp.com/PrinterInitialization/Printer472.html.”

Referring now to block 220, a network connection is established by means of the communications module 40.

Referring to block 230, a request containing the peripheral device ID is sent to the network to request execution of at least one initialization task. In one embodiment of the present invention where the peripheral device ID is contained within a URL, the URL is used to access a server computer on the Internet to request execution of the initialization task. For example, this URL site could be accessed by means of the peripheral device's Java Virtual Machine. In another embodiment of the present invention, the server computer could be accessed via the network, with the server computer address obtained, by way of example, from the nonvolatile memory in the peripheral device.

Referring now to block 240, the accessed computer searches a predetermined storage (locally or on the network) using the peripheral device ID as the search term to locate any initialization task for the peripheral device ID. Alternatively, a server computer (operating as an internet site) may retrieve an initialization task from its database using the peripheral device ID buried within the URL. It should be noted that in a preferred embodiment, the ID for the peripheral device is an IP address.

Referring now to the initialization task, a variety of different initialization tasks may be accessed. By way of example, such an initialization task, which may be set forth in script, might include such items as a list and location of soft fonts to download; a list and location of forms and templates to download; a location of a localization file to download and use; a set of security keys, permissions, passwords, and other similar security information that is to be stored in the RAM for the peripheral device; a URL of a timeserver from which to set the real-time clock for the peripheral device; and a list of network drives to mount. As a further example of a typical initialization task, an appendix is set forth with an example. This appendix describes a first line of script comprising a command to cause a computer to send to a printer 472 a specified font style. The appendix includes a second line of script which comprises a command to send to a computer A an instruction to execute which will cause the computer A to send a font style to the printer 472. The appendix further includes a line of script comprising a command to cause the computer A to send the printer 472 a setting for the number of copies to be made. The appendix further includes a line of script comprising a command to cause the computer A to send to the printer 472 a setting to turn off the duplex.

Referring now to block 250, the initialization task is executed to cause a communication to the peripheral device to initialize the peripheral device. By way of example but not by way of limitation, the server computer might execute the initialization task to cause a particular style, such as a font style, to be loaded to the peripheral device.

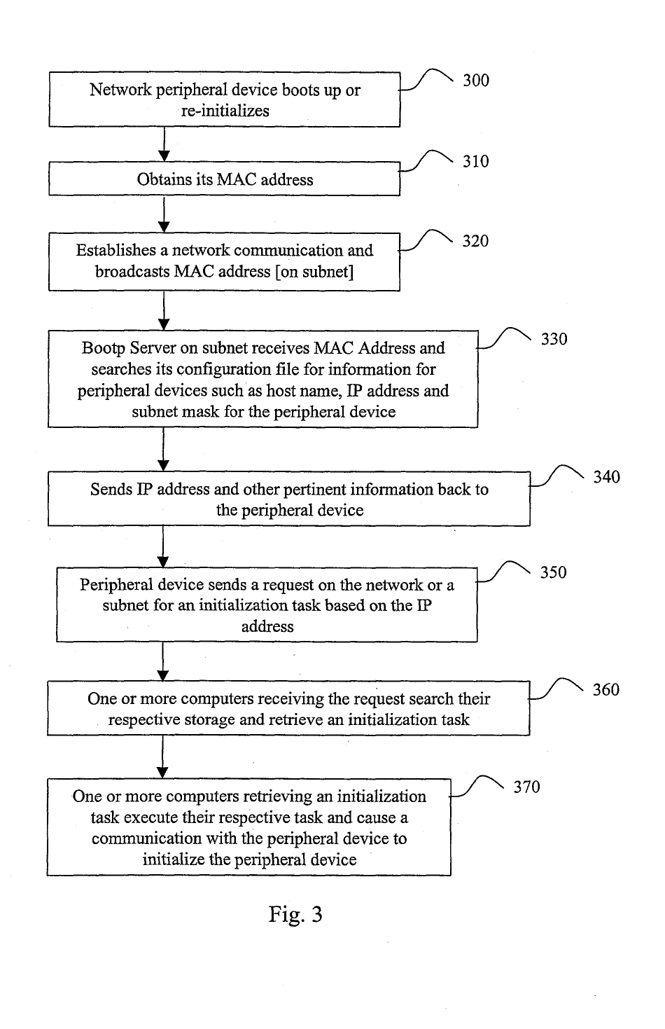

Referring now to FIG. 3, a second embodiment of a message for the present invention is shown. Referring now to block 300, the peripheral device boots up or re-initializes. Referring to block 310, a MAC address or comparable address is obtained for the peripheral device. Typically, such a MAC address is stored in a ROM or a PROM for the peripheral device.

Referring to block 320, the boot program establishes a network communication and the MAC address is broadcast on the network. More typically, this broadcast of the MAC address will be only on a subnet containing the peripheral device.

Referring now to block 330, a bootp server on the subnet receives the MAC address and searches its configuration file for information relating to the peripheral device such as the host name, IP address, and subnet maps for the peripheral device based on the MAC address.

Referring to block 340, the bootp server sends the IP address and other pertinent information obtained from the configuration file back to the peripheral device.

Referring to block 350, the peripheral device then sends a request on the network for an initialization task based on the retrieved IP address. This request may be sent to one or more individual computers on the network or on a subnet, or may be broadcast on the network or on a subnet.

Referring to block 360, one or more computers receiving the request with the IP address or other ID searches its respective storage and retrieves an initialization task.

Referring to block 370, the one or more computers each retrieves a different initialization task for a different aspect of initialization, executes its respective task and causes a communication with the peripheral device to initialize the peripheral device in accordance with its respective initialization task. As noted previously, the task might include loading a font, or a list and location of forms and templates, or a set of security keys and permissions, and passwords to be loaded into the memory of the peripheral device, or any other type of initialization of the peripheral device.

It can be seen that more than one computer may respond to the request on the subnet or the network for an initialization task. Accordingly, multiple initialization communications may occur either simultaneously or within a short period of time. There will be situations where certain of the initialization tasks must be performed before other of the initialization tasks. In order to accomplish this sequence of task performance, each of the initialization tasks can be given a priority designation, with the peripheral device loading or otherwise initializing in accordance with this priority.

The foregoing description of a preferred embodiment of the invention has been presented for purpose of illustration and description. It is not intended to be exhaustive or to limit the invention to the precise form disclosed, and modifications and variations are possible in light of the teachings or may be acquired from practice of the invention. The embodiment was chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalent.

[image]

1. A method for customizing a network peripheral device, comprising the steps of:
sending a request with an ID for the peripheral device to a computer on the network requesting at least one initialization task;
the computer searching a memory for the initialization task based on the peripheral device ID and retrieve that initialization task; and
executing the retrieved task to cause a communication with the peripheral device to initialize the peripheral device.

2. The method as defined in claim 1, wherein the ID for the peripheral device is an IP address.

3. The method as defined in claim 2, wherein the IP address is stored in a non-volatile memory of the peripheral device.

4. The method as defined in claim 1, wherein the sending a request step comprises:
obtaining a MAC address or equivalent for the peripheral device;
broadcasting the MAC address on the network or on a subnet;
obtaining an IP address that correlates to the MAC address; and
sending the IP address as the ID of the peripheral device to the computer and requesting at least one initialization task.

5. The method as defined in claim 1, wherein the initialization task is a script.

6. The method as defined in claim 1, wherein the initialization task obtains a font from a location on the network and downloads the font to initialize the peripheral device with the font.

7. The method as defined in claim 1, wherein the initialization task obtains a list and location of forms and/or templates from a location on the network and downloads them to initialize the peripheral device.

8. The method as defined in claim 1, wherein the initialization task obtains a set of security keys, permissions, and/or passwords from a location on the network and downloads them a memory to initialize the peripheral device.

9. The method as defined in claim 1, wherein the peripheral device ID is contained within a URL, and wherein the URL contains an address to a computer on the network, and the URL is used to request execution of the initialization task.

10. The method as defined in claim 1, wherein the peripheral device is a printer.

11. The method as defined in claim 1, wherein the sending step comprises broadcasting the request on the network.

12. The method as defined in claim 1, wherein each of a plurality of different computers on the network retrieves a different initialization task and executes its respective retrieved initialization task to cause a communication with the peripheral device to initialize a different aspect of the peripheral device.

13. The method as defined in claim 12, wherein each of the different initialization tasks has a priority, and wherein the peripheral device receives the different communications and then initializes in the sequence of the priority.

14. A peripheral device, comprising:
a device functional engine;
a network communications module;
a small non-volatile memory containing an ID or a reference for an ID for the peripheral device; and
a boot program that sends a request via the network communications module for an initialization task and receives a communication from the network that initializes the peripheral device.

15. The peripheral device as defined in claim 14, wherein the device functional engine is a print engine.

16. The peripheral device as defined in claim 14, wherein the peripheral device ID is contained within a URL, and wherein the URL contains an address to a computer on the network, and the URL is used to request execution of the initialization task.

17. The peripheral device as defined in claim 14, wherein the small non-volatile storage contains a reference for the ID comprising a MAC address, and wherein the boot program contains code to cause the broadcast of the MAC address on the network or a subnet.

18. The peripheral device as defined in claim 17, wherein the network or subnet includes a bootp server with a configuration file that correlates to the MAC address, and wherein the configuration file contains the ID for the peripheral device, and wherein the bootp server sends the ID for the peripheral device to the peripheral device.

19. The peripheral device as defined in claim 14, wherein the network includes a plurality of listening computers, and wherein the boot program contains code to send the request for an initialization task via the network communications module to the plurality of listening computers, and wherein the peripheral device receives a different communication from a plurality of the different listening computers, with each communication initializing a different aspect of the peripheral device.
